(19) United States
(12) Patent Application Publication
(10) Pub. No.: US 2026/0350856 A1
(43) Pub. Date: Nov. 5, 2026

(54) PRODUCING A MAP OF A PARKING FACILITY

(71) Applicant: Toyota Motor Engineering & Manufacturing North America, Inc., Plano, TX (US)

(72) Inventors: Ajitesh Shukla, Mountain View, CA (US); Xiaofei Cao, Mountain View, CA (US); Yusuke Takeuchi, Cupertino, CA (US); Emrah Akin Sisbot, Menlo Park, CA (US); Hangquan Zhao, Mountain View, CA (US); Yongkang Liu, Mountain View, CA (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 19/280,705

(22) Filed: Jul. 25, 2025

Related U.S. Application Data
(60) Provisional application No. 63/797,451, filed on Apr. 30, 2025.

(51) Int. Cl. G06T 11/00; G06T 7/11

(52) U.S. Cl. CPC G06T 11/00; G06T 7/11; G06T 2207/10032; G06T 2207/20084; G06T 2207/30232; G06T 2210/12

(57) ABSTRACT

A system for producing a map of a parking facility can include a processor and a memory. The memory can store an ensemble of experts module and a communications module. The ensemble of experts module can include instructions that cause the processor to: (1) segment, operating at least one first neural network-based model, a remote sensing image of the parking facility to produce bounding boxes of parking blocks, (2) segment, operating at least one second neural network-based model, an object, in the remote sensing image, associated with obscuring the bounding boxes, and (3) modify, to produce the map of the parking facility, the bounding boxes to account for an effect of the object. The communications module can include instructions that cause the processor to communicate the map to a device associated with a vehicle to control an operation of the device.

### CROSS-REFERENCE TO RELATED APPLICATIONS

This application claims the benefit of U.S. Provisional Application No. 63/797,451, filed Apr. 30, 2025, which is incorporated herein in its entirety by reference.

### TECHNICAL FIELD

The disclosed technologies are directed to producing a map of a parking facility.

### BACKGROUND

A digital map can be an electronic representation of a conventional paper map. For example, an automotive navigation system can use information received from a digital map and information received from a global navigation satellite system (GNSS) to produce a turn-by-turn navigation service. A turn-by-turn navigation service can provide a route between an origination point and a destination point. A position of a vehicle determined by such a turn-by-turn navigation service can be within a meter of an actual position.

More recently, technologies have been developed to automate one or more operations of one or more vehicle systems to control movement of a vehicle. Such technologies can use information received from a digital map to control such movement. Such technologies can include, for example, an automated valet parking system. An automated valet parking system can be a system that can cause a vehicle, without a presence of an operator within the vehicle, to navigate within a parking facility and to park in a parking spot. However, a digital map used for such a purpose can be required to indicate positions of objects with a degree of accuracy that is within a decimeter. Accordingly, development of technologies to automate control of movement of vehicles have been accompanied by efforts to improve the degree of accuracy of digital maps. This has led to the production of high-definition (HD) maps.

### SUMMARY

In an embodiment, a system for producing a map of a parking facility can include a processor and a memory. The memory can store an ensemble of experts module and a communications module. The ensemble of experts module can include instructions that cause the processor to: (1) segment, operating at least one first neural network-based model, a remote sensing image of the parking facility to produce bounding boxes of parking blocks, (2) segment, operating at least one second neural network-based model, an object, in the remote sensing image, associated with obscuring the bounding boxes, and (3) modify, to produce the map of the parking facility, the bounding boxes to account for an effect of the object. The communications module can include instructions that cause the processor to communicate the map to a device associated with a vehicle to control an operation of the device.

In another embodiment, a method for producing a map of a parking facility can include segmenting, by a processor operating at least one first neural network-based model, a remote sensing image of the parking facility to produce bounding boxes of parking blocks. The method can include segmenting, by the processor operating at least one second neural network-based model, an object, in the remote sensing image, associated with obscuring the bounding boxes. The method can include modifying, by the processor to produce the map of the parking facility, the bounding boxes to account for an effect of the object. The method can include communicating, by the processor, the map to a device associated with a vehicle to control an operation of the device.

In another embodiment, a non-transitory computer-readable medium for producing a map of a parking facility can include instructions that, when executed by one or more processors, cause the one or more processors to segment, operating at least one first neural network-based model, a remote sensing image of the parking facility to produce bounding boxes of parking blocks. The non-transitory computer-readable medium can include instructions that, when executed by one or more processors, cause the one or more processors to segment, operating at least one second neural network-based model, an object, in the remote sensing image, associated with obscuring the bounding boxes. The non-transitory computer-readable medium can include instructions that, when executed by one or more processors, cause the one or more processors to modify, to produce the map of the parking facility, the bounding boxes to account for an effect of the object. The non-transitory computer-readable medium can include instructions that, when executed by one or more processors, cause the one or more processors to communicate the map to a device associated with a vehicle to control an operation of the device.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 includes a diagram that illustrates an example of an environment for producing a map of a parking facility, according to the disclosed technologies.

FIG. 2 includes a block diagram that illustrates an example of a system for producing a map of a parking facility, according to the disclosed technologies.

FIG. 3 includes a diagram of an example of a remote sensing image that includes the parking facility illustrated in FIG. 1, according to the disclosed technologies.

FIG. 4 includes a diagram of a first example of a segmentation of the remote sensing image, illustrated in FIG. 3, according to the disclosed technologies.

FIG. 5 includes a diagram of a second example of a segmentation of the remote sensing image, illustrated in FIG. 3, according to the disclosed technologies.

FIG. 6 includes a diagram of an example of a merged parking block mask, according to the disclosed technologies.

FIG. 7 includes a diagram of an example of bounding boxes of parking blocks, according to the disclosed technologies.

FIG. 8 includes a diagram of an example of a modification of the bounding boxes of the parking blocks to account for the effect of the tree, illustrated in FIG. 3, according to the disclosed technologies.

FIG. 9 includes a diagram of an example of the bounding boxes of the parking blocks and object bounding boxes for the first vehicle and the second vehicle, illustrated in FIG. 3, according to the disclosed technologies.

FIG. 10 includes a diagram of an example of the map of the parking facility, illustrated in FIG. 3, according to the disclosed technologies.

FIG. 11 includes a flow diagram that illustrates an example of a method that is associated with producing a map of a parking facility, according to the disclosed technologies.

FIG. 12 includes a block diagram that illustrates an example of elements disposed on a vehicle, according to the disclosed technologies.

### DETAILED DESCRIPTION

The disclosed technologies are directed to producing a map of a parking facility. For example, the map can include one or more of a digital map, a high-definition (HD) map, or the like. For example, the map can include a vector map. For example, the parking facility can include a parking lot, a level of a parking garage, or the like. For example, a remote sensing image of the parking facility can be segmented, using one or more first neural network-based models, to produce bounding boxes of parking blocks. For example, the remote sensing image can include one or more of a georeferenced image, an aerial image, a satellite image, or the like. For example, the remote sensing image can include one or more of an RGB image, an infrared image, or the like. For example, if the parking facility is a level of a parking garage, then the remote sensing image can be from a perspective of a surveillance camera. For example, an object, in the remote sensing image, associated with obscuring the bounding boxes, can be segmented using one or more second neural network-based models. For example, to produce the map, the bounding boxes can be modified to account for an effect of the object. For example, the map can be communicated to a device associated with a vehicle to control an operation of the device.

For example, the one or more first neural network-based models can include a first first neural network-based model and second first neural network-based model. For example, the first first neural network-based model can be a parking facility segmentation expert model configured to segment an overall layout of the parking facility to produce one or more parking facility masks. For example, the second first neural network-based model can be a parking block segmentation expert model configured to segment individual parking blocks to produce one or more parking block masks. For example, a parking block can be a row of parking spots in which all of the parking spots are oriented in a same direction. For example, the remote sensing image can be segmented to produce the bounding boxes of the parking blocks by: (1) merging the one or more parking facility masks and the one or more parking block masks to produce a merged parking block mask and (2) extracting one or more bounding boxes to define one or more parking blocks. For example, a production of the merged parking block mask can remove one or more false positive indications, associated with a parking block, in the one or more parking block masks.

For example, the object can include a first object and a second object. For example, the one or more second neural network-based models can include a shadow removal expert model configured to: (1) identify the second object as a shadow of the first object and (2) segment the second object. Additionally or alternatively, for example, the one or more second neural network-based models can include a tree segmentation expert model configured to: (1) identify the object as a tree and (2) segment the object. Additionally or alternatively, for example, the one or more second neural network-based models can include a parked vehicle detection expert model configured to: (1) identify the object as a vehicle, (2) segment the object, and (3) extract an object bounding box for the object.

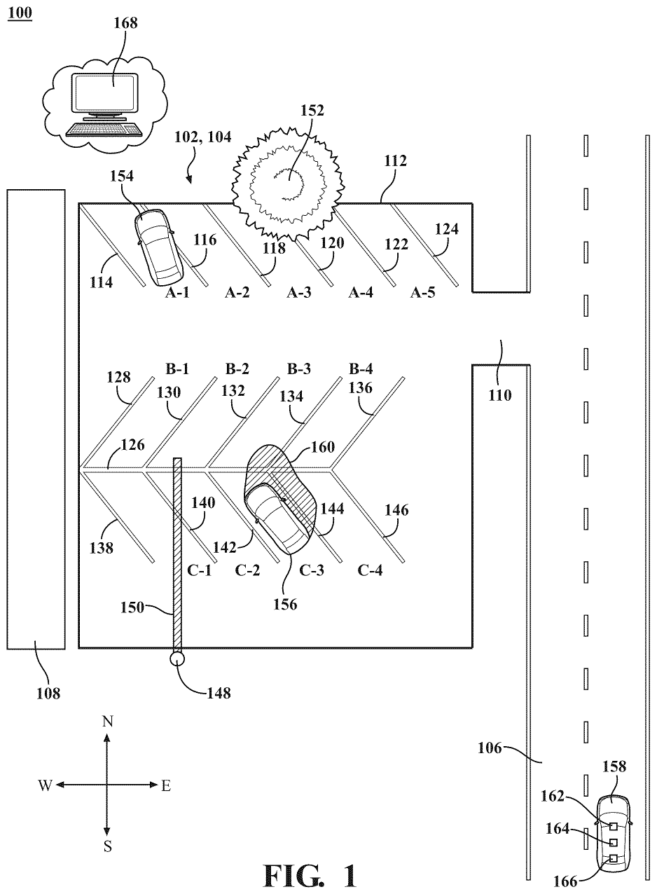

FIG. 1 includes a diagram that illustrates an example of an environment 100 for producing a map of a parking facility 102, according to the disclosed technologies. For example, the environment 100 can include a parking lot 104, a road 106, and a building 108. For example, the road 106 can be located along a line of longitude east of the parking lot 104. For example, the building 108 can be located west of the parking lot 104. For example, the parking lot 104 can include thirteen parking spots in three rows. For example, from north to south, the three rows can include a row A, a row B, and a row C. For example, from west to east, the row A can include a parking spot A-1, a parking spot A-2, a parking spot A-3, a parking spot A-4, and a parking spot A-5. For example, from west to east, the row B can include a parking spot B-1, a parking spot B-2, a parking spot B-3, and a parking spot B-4. For example, from west to east, the row C can include a parking spot C-1, a parking spot C-2, a parking spot C-3, and a parking spot C-4.

For example, an accessway 110 can be located between the parking lot 104 and the road 106. For example, the accessway 110 can be located along a line of latitude. For example, an aisle between the row A and the row B can be located along this line of latitude. For example, each of the parking spots can be an angled parking spot. For example, for each of the parking spots, an acute angle can be formed between a parking stop and a parking spot line. For example, the acute angle can be forty-five degrees. For example, parking spot lines can be disposed on a surface of the parking lot 104 so that a point on a parking spot line at an entrance of a parking spot is east of a point on the parking spot line at a parking stop of the parking spot. For example, a “rooftop” pattern can be formed by a parking spot line of the row B and a parking spot line of the row C in which a point at a parking stop of the parking spot line of the row B is the point at the parking stop of the parking spot line of the row C.

For example, the parking spots included in the row A can have a parking stop 112. For example, a west side of the parking spot A-1 can have a parking spot line 114, the parking spot A-1 and the parking spot A-2 can have a parking spot line 116, the parking spot A-2 and the parking spot A-3 can have a parking spot line 118, the parking spot A-3 and the parking spot A-4 can have a parking spot line 120, the parking spot A-4 and the parking spot A-5 can have a parking spot line 122, and an east side of the parking spot A-5 can have a parking spot line 124. For example, the parking spots included in the row B and the row C can have a parking stop 126. For example, a west side of the parking spot B-1 can have a parking spot line 128, the parking spot B-1 and the parking spot B-2 can have a parking spot line 130, the parking spot B-2 and the parking spot B-3 can have a parking spot line 132, the parking spot B-3 and the parking spot B-4 can have a parking spot line 134, and an east side of the parking spot B-4 can have a parking spot line 136. For example, a west side of the parking spot C-1 can have a parking spot line 138, the parking spot C-1 and the parking spot C-2 can have a parking spot line 140, the parking spot C-2 and the parking spot C-3 can have a parking spot line 142, the parking spot C-3 and the parking spot C-4 can have a parking spot line 144, and an east side of the parking spot C-4 can have a parking spot line 146.

For example, the environment 100 can include a street light 148 located south of the parking lot 104 along a line of longitude that intersects the parking spot A-2, the parking spot B-2, and the parking spot C-2. For example, the street light 148 can have a shadow 150 that obscures some of the parking spot lines of the parking spots in the row B and the row C.

For example, the environment 100 can include a tree 152 located north of the parking lot 104 along a line of longitude that intersects the parking spot A-3, the parking spot B-3, and the parking spot C-3. For example, from a bird's eye point of view, branches of the tree 152 can obscure some of the parking spot lines in the row A.

For example, the environment 100 can include a first vehicle 154, a second vehicle 156, and a third vehicle 158. For example, the first vehicle 154 can be parked in the parking spot A-1 in a manner such that, from a bird's eye point of view, a portion of the parking spot line between the parking spot A-1 and the parking spot A-2 can be obscured by the first vehicle 154. For example, the second vehicle 156 can be parked in the parking spot C-3 and have a shadow 160 that obscures some of the parking spot lines of the parking spots in the row B and the row C. For example, the third vehicle 158 can be located in a northbound lane of the road 106 south of the parking lot 104. For example, the third vehicle 158 can have a processor 162, a memory 164, and a communications device 166.

For example, the environment 100 can include a cloud computing platform 168.

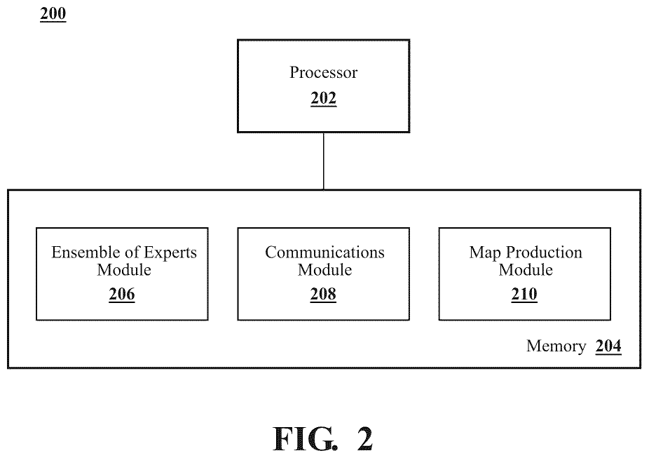

FIG. 2 includes a block diagram that illustrates an example of a system 200 for producing a map of a parking facility, according to the disclosed technologies. The system 200 can include, for example, a processor 202 and a memory 204. The memory 204 can be communicably coupled to the processor 202. For example, the memory 204 can store an ensemble of experts module 206 and a communications module 208. For example, the parking facility can include a parking lot, a level of a parking garage, or the like.

For example, the ensemble of experts module 206 can include instructions that function to control the processor 202 to segment, operating one or more first neural network-based models, a remote sensing image of the parking facility to produce bounding boxes of parking blocks.

For example, the remote sensing image can include one or more of a georeferenced image, an aerial image, a satellite image, or the like. For example, the remote sensing image can include one or more of an RGB image, an infrared image, or the like. For example, if the parking facility is a level of a parking garage, then the remote sensing image can be from a perspective of a surveillance camera.

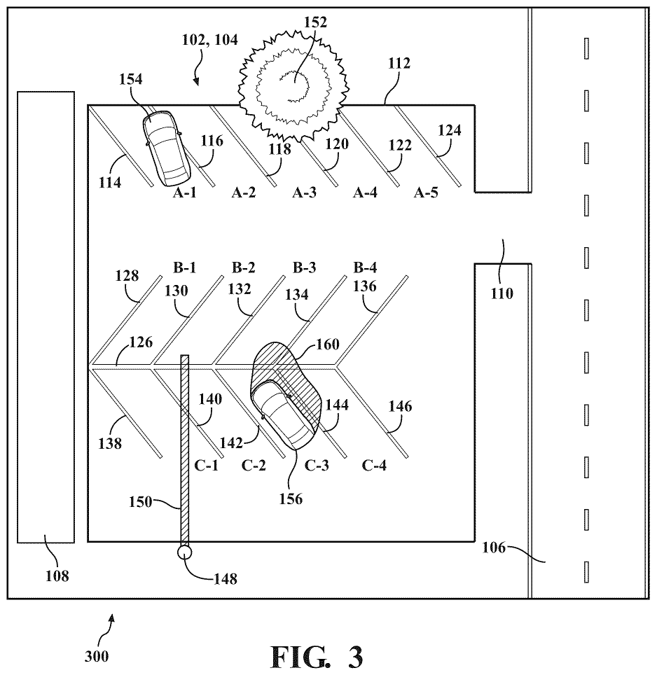

FIG. 3 includes a diagram of an example of a remote sensing image 300 that includes the parking facility 102 illustrated in FIG. 1, according to the disclosed technologies. For example, the remote sensing image 300 can be a satellite image. With reference to FIGS. 1 and 3, for example, the remote sensing image 300 can include the parking lot 104, a portion of the road 106, the building 108, the accessway 110, the parking stop 112, the parking spot line 114, the parking spot line 116, the parking spot line 118, the parking spot line 120, the parking spot line 122, the parking spot line 124, the parking stop 126, the parking spot line 128, the parking spot line 130, the parking spot line 132, the parking spot line 134, the parking spot line 136, the parking spot line 138, the parking spot line 140, the parking spot line 142, the parking spot line 144, the parking spot line 146, the street light 148, the shadow 150 of the street light 148, the tree 152, the first vehicle 154, the second vehicle 156, and the shadow 160 of the second vehicle 156.

For example, the one or more first neural network-based models can include a first first neural network-based model and second first neural network-based model. For example, the first first neural network-based model can be a parking facility segmentation expert model configured to segment an overall layout of the parking facility to produce one or more parking facility masks.

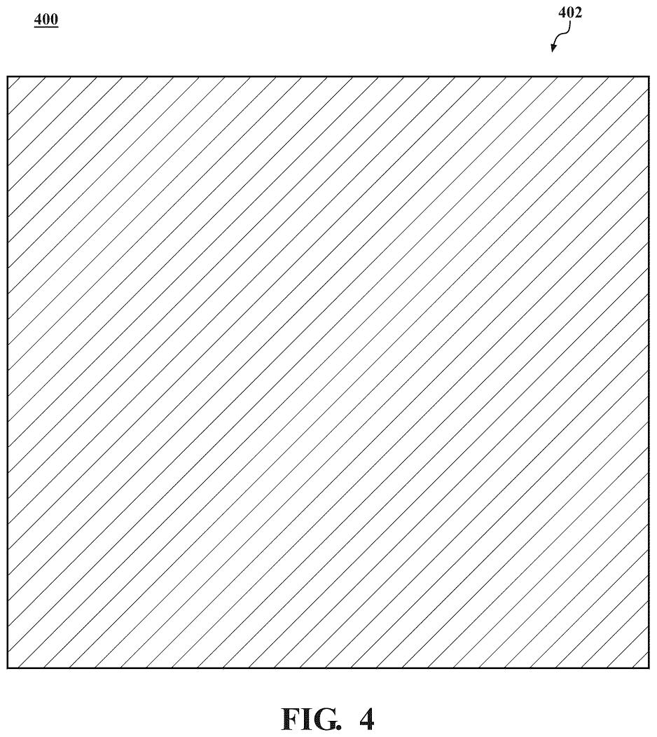

FIG. 4 includes a diagram of a first example 400 of a segmentation of the remote sensing image 300, illustrated in FIG. 3, according to the disclosed technologies. For example, the parking facility segmentation expert model can produce the segmentation. With reference to FIGS. 3 and 4, for example, the segmentation can produce a parking facility mask 402 of the parking facility 102. For example, the parking facility mask 402 can illustrate a boundary of the parking facility 102, but not differentiate individual parking blocks or individual parking spots.

For example, the second first neural network-based model can be a parking block segmentation expert model configured to segment individual parking blocks to produce one or more parking block masks. For example, a parking block can be a row of parking spots in which all of the parking spots are oriented in a same direction. With reference to FIG. 3, for example, because all of the parking spots in each the row A, the row B, and the row C are oriented in a same direction, each of the row A, the row B, and the row C can be considered to include one or more parking blocks.

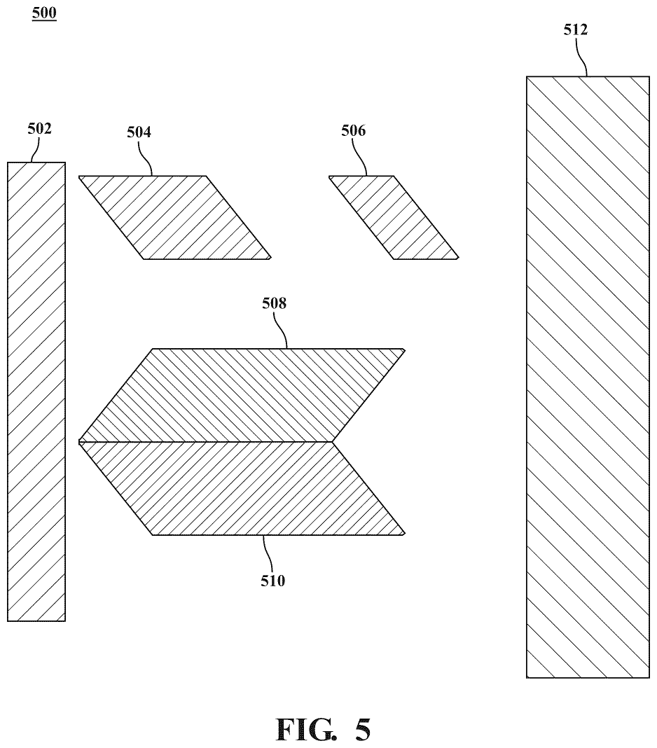

FIG. 5 includes a diagram of a second example 500 of a segmentation of the remote sensing image 300, illustrated in FIG. 3, according to the disclosed technologies. For example, the parking block segmentation expert model can produce the segmentation. With reference to FIGS. 3 and 5, for example, the segmentation can produce: (1) a first parking block mask 502, which can illustrate a boundary of the building 108, (2) a second parking block mask 504, which can illustrate a boundary of a western portion of the row A, (3) a third parking block mask 506, which can illustrate a boundary of an eastern portion of the row A, (4) a fourth parking block mask 508, which can illustrate a boundary of the row B, (5) a fifth parking block 510, which can illustrate a boundary of the row C, and (6) a sixth parking block 512, which can illustrate a boundary of the portion of the road 106. That is, because each of the boundary of the building 108 and the boundary of the portion of the road 106 can resemble a parking block, the parking block segmentation expert model may erroneously identify one or more of the building 108 or the portion of the road 106 as parking blocks (i.e., false positive indications).

For example, the instructions to segment the remote sensing image to produce the bounding boxes of the parking blocks can include: (1) instructions to merge the one or more parking facility masks and the one or more parking block masks to produce a merged parking block mask and (2) instructions to extract one or more bounding boxes to define one or more parking blocks. For example, the instructions to merge the one or more parking facility masks and the one or more parking block mask can include instructions to perform a pixel-wise AND combination of the one or more parking facility masks and the one or more parking block masks. For example, the instructions to merge the one or more parking facility masks and the one or more parking block masks can include instructions to remove one or more false positive indications, associated with a parking block, in the one or more parking block masks.

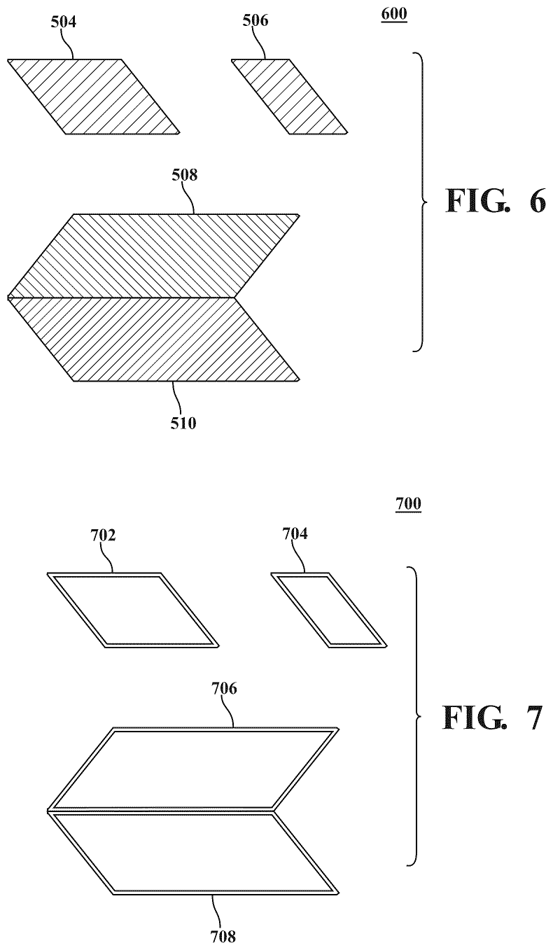

FIG. 6 includes a diagram of an example 600 of a merged parking block mask, according to the disclosed technologies. With reference to FIGS. 3-6, for example, the merged parking block mask can include: (1) the second parking block mask 504, which can illustrate the boundary of the western portion of the row A, (2) the third parking block mask 506, which can illustrate the boundary of the eastern portion of the row A, (3) the fourth parking block mask 508, which can illustrate the boundary of the row B, and (4) the fifth parking block 510, which can illustrate the boundary of the row C.

FIG. 7 includes a diagram of an example 700 of bounding boxes of parking blocks, according to the disclosed technologies. With reference to FIGS. 3 and 7, for example, the bounding boxes can include: (1) a first bounding box 702 of a parking block associated with the western portion of the row A, (2) a second bounding box 704 of a parking block associated with the eastern portion of the row A, (3) a third bounding box 706 of a parking block associated with the row B, and (4) a fourth bounding box 708 of a parking block associated with the row C.

Returning to FIG. 2, for example, the ensemble of experts module 206 can include instructions that function to control the processor 202 to segment, operating one or more second neural network-based models, an object, in the remote sensing image, associated with obscuring the bounding boxes.

For example, the ensemble of experts module 206 can include instructions that function to control the processor 202 to modify, to produce the map of the parking facility, the bounding boxes to account for an effect of the object. For example, the map can include one or more of a digital map, a high-definition (HD) map, or the like. For example, the map can include a vector map.

For example, the one or more second neural network-based models can include a shadow removal expert model. For example, the object can include a first object and a second object. For example, the shadow removal expert model can be configured to: (1) identify the second object as a shadow of the first object and (2) segment the second object.

Additionally or alternatively, for example, the one or more second neural network-based models can include a tree segmentation expert model. For example, the tree segmentation expert model can be configured to: (1) identify the object as a tree and (2) segment the object.

For example, in a specific implementation, the one or more second neural network-based models can include a first second neural network-based model. For example, the first second neural network-based model can be the tree segmentation expert model. For example, the instructions to modify the bounding boxes to account for the effect of the object can include: (1) instructions to identify, among the one or more bounding box, two bounding boxes that overlap a segmentation of the object, (2) instructions to connect the two bounding boxes to produce one or more refined bounding boxes to define a single parking block, and (3) instructions to extract parking spot lines within at least one of the one or more bounding boxes or the one or more refined bounding boxes.

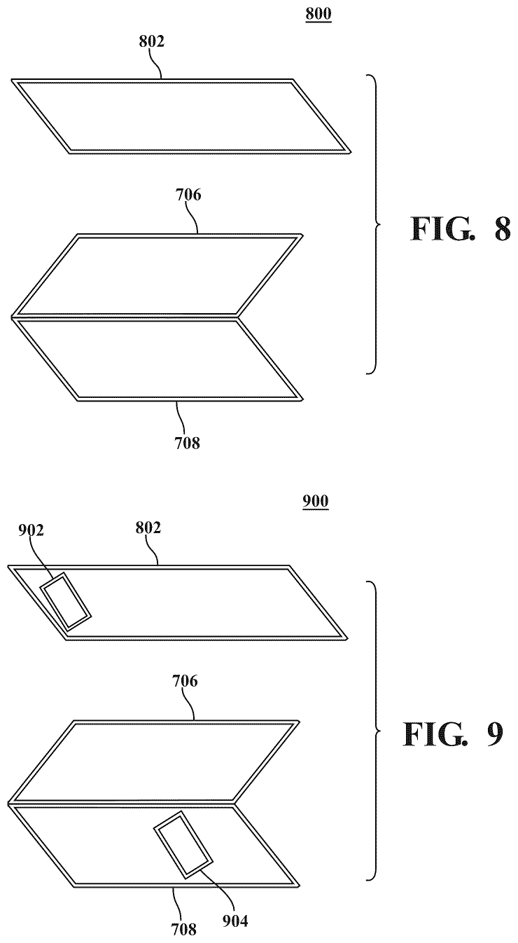

FIG. 8 includes a diagram of an example 800 of a modification of the bounding boxes of the parking blocks to account for the effect of the tree 152, illustrated in FIG. 3, according to the disclosed technologies. With reference to FIGS. 3 and 8, for example: (1) among the first bounding box 702, the second bounding box 704, the third bounding box 706, and the fourth bounding box 708, the two bounding boxes that overlap the segmentation of the tree 152 can be identified as the first bounding box 702 and the second bounding box 704 and (2) the first bounding box 702 and the second bounding box 704 can be connected to produce a refined bounding box 802 to define a single parking bock. For example, the bounding boxes can include: (1) the refined bounding box 802 of the parking block associated with the row A, (2) the third bounding box 706 of the parking block associated with the row B, and (3) the fourth bounding box 708 of the parking block associated with the row C.

With reference to FIGS. 3 and 8, for example: (1) the parking stop 112, the parking spot line 114, the parking spot line 116, the parking spot line 118, the parking spot line 120, the parking spot line 122, and the parking spot line 124 can be extracted within the refined bounding box 802, (2) the parking stop 126, the parking spot line 128, the parking spot line 130, the parking spot line 132, the parking spot line 134, and the parking spot line 136 can be extracted within the third bounding box 706, and (3) the parking stop 126, the parking spot line 138, the parking spot line 140, the parking spot line 142, the parking spot line 144, and the parking spot line 146 can be extracted within the fourth bounding box 708.

Additionally or alternatively, for example, the one or more second neural network-based models can include a parked vehicle detection expert model. For example, the parked vehicle detection expert model can be configured to: (1) identify the object as a vehicle, (2) segment the object, and (3) extract an object bounding box for the object.

For example, in the specific implementation, the one or more second neural network-based models can further include a second second neural network-based model. For example, the second second neural network-based model can be the parked vehicle detection expert model. For example, the object can include a first object and a second object. For example, the first object can be the tree. For example, the parked vehicle detection expert model can be configured to: (1) identify the second object as the vehicle, (2) segment the second object, and (3) extract the object bounding box for the second object.

FIG. 9 includes a diagram of an example 900 of the bounding boxes of the parking blocks and object bounding boxes for the first vehicle 154 and the second vehicle 156, illustrated in FIG. 3, according to the disclosed technologies. With reference to FIGS. 3 and 9, for example, the bounding boxes can include: (1) the refined bounding box 802 of the parking block associated with the row A, (2) the third bounding box 706 of the parking block associated with the row B, (3) the fourth bounding box 708 of the parking block associated with the row C, (4) a first object bounding box 902 for the first vehicle 154, and (5) a second object bounding box 904 for the second vehicle 156.

For example, the effect of the object can be an effect of the second object. For example, the effect of the second object can include one or more of: (1) a location of the second object obscures a parking spot line or (2) a shadow of the second object obscures the parking spot line. With reference to FIG. 3, for example: (1) the location of the first vehicle 154 can obscure a portion of the parking spot line 116 and (2) the shadow 160 of the second vehicle 156 can obscure: (a) a portion of the parking stop 126, (b) a portion of the parking spot line 144, and (c) a portion of the parking spot line 134.

Returning to FIG. 2, additionally, for example, the memory 204 can further store a map production module 210. For example, the map production module 210 can include instructions that function to control the processor 202 to: (1) cluster the parking spot lines and the object bounding box to produce refined parking spot lines and (2) add, to produce the map of the parking facility, possible missing parking spot lines by one or more of: (a) interpolating with respect to one or more of the one or more bounding boxes or the one or more refined bounding boxes or (b) extending a partial parking spot line.

For example, the instructions to cluster the parking spot lines and the object bounding box can include a hierarchical technique that: (1) identifies angle clusters, (2) identifies distance clusters within the angle clusters, and (3) merges lines within each distance cluster, within the distance clusters, into a single representation. For example, the instructions to add the possible missing parking spot lines can include instructions to verify a preliminary determination of a size of a parking spot with respect to a standard size of the parking spot. For example, in the United States, the standard size of a parking spot can have a width of nine feet and a length of eighteen feet.

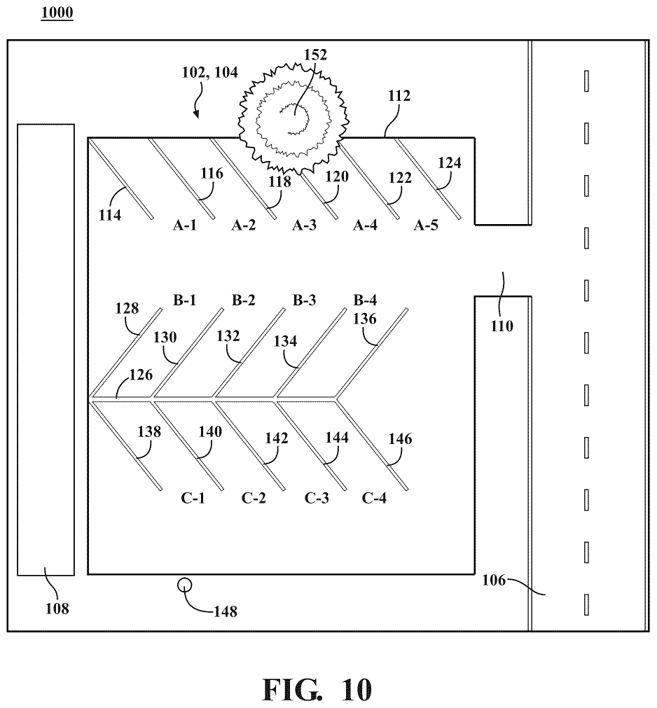

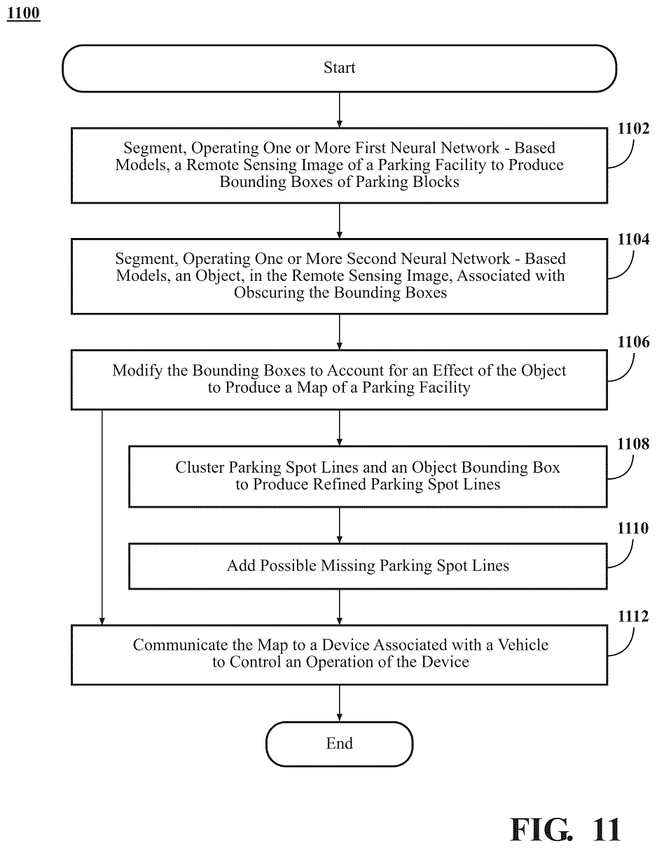

FIG. 10 includes a diagram of an example of the map 1000 of the parking facility 102, illustrated in FIG. 3, according to the disclosed technologies. For example, the map 1000 can include the parking lot 104, the portion of the road 106, the building 108, the accessway 110, the parking stop 112, the parking spot line 114, the parking spot line 116, the parking spot line 118, the parking spot line 120, the parking spot line 122, the parking spot line 124, the parking stop 126, the parking spot line 128, the parking spot line 130, the parking spot line 132, the parking spot line 134, the parking spot line 136, the parking spot line 138, the parking spot line 140, the parking spot line 142, the parking spot line 144, and the parking spot line 146.

Returning to FIG. 2, for example, the communications module 208 can include instructions that function to control the processor 202 to communicate the map to a device associated with a vehicle to control an operation of the device. For example, the device associated with the vehicle can include one or more of: (1) a device associated with an automated valet parking system, (2) a device associated with a smart parking system, (3) a device associated with a system configured to produce a parking spot recommendation, (4) a device associated with a system configured to determine an optimal route to a parking spot, or (5) the like. For example, the device associated with the automated valet parking system can include a device configured to cause a movement of a component of the vehicle.

In a first example, the system 200 can be disposed on a cloud computing platform. For example, the instructions to communicate the map to the device associated with the vehicle can include instructions to communicate the map to the vehicle. With reference to FIG. 1, for example, the cloud computing platform can be the cloud computing platform 168 and the vehicle can be the third vehicle 158. For example, the cloud computing platform 168 can communicate the map to the third vehicle 158 via the communications device 166.

Returning to FIG. 2, alternatively, in a second example, the system 200 can be disposed on a vehicle. With reference to FIGS. 1-3, for example, the vehicle can be the third vehicle 158. For example, the processor 202 can be the processor 162 and the memory 204 can be the memory 164. For example, the third vehicle 158 can obtain the remote sensing image 300 via the communications device 166.

FIG. 11 includes a flow diagram that illustrates an example of a method 1100 that is associated with producing a map of a parking facility, according to the disclosed technologies. Although the method 1100 is described in combination with the system 200 illustrated in FIG. 2, one of skill in the art understands, in light of the description herein, that the method 1100 is not limited to being implemented by the system 200 illustrated in FIG. 2. Rather, the system 200 illustrated in FIG. 2 is an example of a system that may be used to implement the method 1100. Additionally, although the method 1100 is illustrated as a generally serial process, various aspects of the method 1100 may be able to be executed in parallel.

In the method 1100, at an operation 1102, for example, the ensemble of experts module 206 can segment, operating one or more first neural network-based models, a remote sensing image of the parking facility to produce bounding boxes of parking blocks.

For example, the remote sensing image can include one or more of a georeferenced image, an aerial image, a satellite image, or the like. For example, the remote sensing image can include one or more of an RGB image, an infrared image, or the like. For example, if the parking facility is a level of a parking garage, then the remote sensing image can be from a perspective of a surveillance camera.

For example, the one or more first neural network-based models can include a first first neural network-based model and second first neural network-based model. For example, the first first neural network-based model can be a parking facility segmentation expert model configured to segment an overall layout of the parking facility to produce one or more parking facility masks. For example, the second first neural network-based model can be a parking block segmentation expert model configured to segment individual parking blocks to produce one or more parking block masks. For example, a parking block can be a row of parking spots in which all of the parking spots are oriented in a same direction.

For example, at the operation 1102, the ensemble of experts module 206 can: (1) merge the one or more parking facility masks and the one or more parking block masks to produce a merged parking block mask and (2) extract one or more bounding boxes to define one or more parking blocks. For example, at the operation 1102, the ensemble of experts module 206 can perform a pixel-wise AND combination of the one or more parking facility masks and the one or more parking block masks. For example, at the operation 1102, the ensemble of experts module 206 can remove one or more false positive indications, associated with a parking block, in the one or more parking block masks.

At an operation 1104, for example, the ensemble of experts module 206 can segment, operating one or more second neural network-based models, an object, in the remote sensing image, associated with obscuring the bounding boxes.

At an operation 1106, for example, the ensemble of experts module 206 can modify, to produce the map of the parking facility, the bounding boxes to account for an effect of the object. For example, the map can include one or more of a digital map, a high-definition (HD) map, or the like. For example, the map can include a vector map.

For example, the one or more second neural network-based models can include a shadow removal expert model. For example, the object can include a first object and a second object. For example, the shadow removal expert model can be configured to: (1) identify the second object as a shadow of the first object and (2) segment the second object.

Additionally or alternatively, for example, the one or more second neural network-based models can include a tree segmentation expert model. For example, the tree segmentation expert model can be configured to: (1) identify the object as a tree and (2) segment the object.

For example, in a specific implementation, the one or more second neural network-based models can include a first second neural network-based model. For example, the first second neural network-based model can be the tree segmentation expert model. For example, at the operation 1106, the ensemble of experts module 206 can: (1) identify, among the one or more bounding box, two bounding boxes that overlap a segmentation of the object, (2) connect the two bounding boxes to produce one or more refined bounding boxes to define a single parking block, and (3) extract parking spot lines within at least one of the one or more bounding boxes or the one or more refined bounding boxes.

Additionally or alternatively, for example, the one or more second neural network-based models can include a parked vehicle detection expert model. For example, the parked vehicle detection expert model can be configured to: (1) identify the object as a vehicle, (2) segment the object, and (3) extract an object bounding box for the object.

For example, in the specific implementation, the one or more second neural network-based models can further include a second second neural network-based model. For example, the second second neural network-based model can be the parked vehicle detection expert model. For example, the object can include a first object and a second object. For example, the first object can be the tree. For example, the parked vehicle detection expert model can be configured to: (1) identify the second object as the vehicle, (2) segment the second object, and (3) extract the object bounding box for the second object. For example, the effect of the object can be an effect of the second object. For example, the effect of the second object can include one or more of: (1) a location of the second object obscures a parking spot line or (2) a shadow of the second object obscures the parking spot line.

Additionally, at an operation 1108, for example, the map production module 210 can cluster the parking spot lines and the object bounding box to produce refined parking spot lines. For example, at the operation 1108, the map production module 210 can use a hierarchical technique that: (1) identifies angle clusters, (2) identifies distance clusters within the angle clusters, and (3) merges lines within each distance cluster, within the distance clusters, into a single representation.

Additionally, at an operation 1110, for example, the map production module 210 can add, to produce the map of the parking facility, possible missing parking spot lines by one or more of: (a) interpolating with respect to one or more of the one or more bounding boxes or the one or more refined bounding boxes or (b) extending a partial parking spot line. For example, at the operation 1110, the map production module 210 can verify a preliminary determination of a size of a parking spot with respect to a standard size of the parking spot. For example, in the United States, the standard size of a parking spot can have a width of nine feet and a length of eighteen feet.

At an operation 1112, for example, the communications module 208 can communicate the map to a device associated with a vehicle to control an operation of the device. For example, the device associated with the vehicle can include one or more of: (1) a device associated with an automated valet parking system, (2) a device associated with a smart parking system, (3) a device associated with a system configured to produce a parking spot recommendation, (4) a device associated with a system configured to determine an optimal route to a parking spot, or (5) the like. For example, the device associated with the automated valet parking system can include a device configured to cause a movement of a component of the vehicle.

In a first example, the method 1100 can be performed on a cloud computing platform. For example, at the operation 1112, the communications module 208 can communicate the map to the vehicle.

Alternatively, in a second example, the method 1100 can be performed on a vehicle.

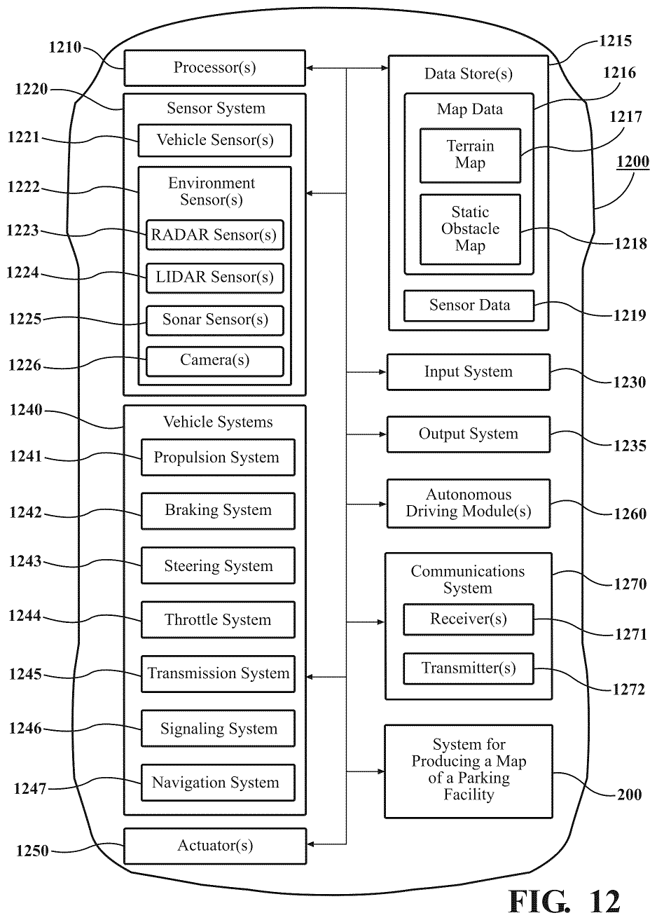

FIG. 12 includes a block diagram that illustrates an example of elements disposed on a vehicle 1200, according to the disclosed technologies. As used herein, a “vehicle” can be any form of powered transport. In one or more implementations, the vehicle 1200 can be an automobile. While arrangements described herein are with respect to automobiles, one of skill in the art understands, in light of the description herein, that embodiments are not limited to automobiles. For example, functions and/or operations of the third vehicle 158 (illustrated in FIG. 1) can be realized by the vehicle 1200.

In some embodiments, the vehicle 1200 can be configured to switch selectively between an automated mode, one or more semi-automated operational modes, and/or a manual mode. Such switching can be implemented in a suitable manner, now known or later developed. As used herein, “manual mode” can refer that all of or a majority of the navigation and/or maneuvering of the vehicle 1200 is performed according to inputs received from a user (e.g., human driver). In one or more arrangements, the vehicle 1200 can be a conventional vehicle that is configured to operate in only a manual mode.

In one or more embodiments, the vehicle 1200 can be an automated vehicle. As used herein, “automated vehicle” can refer to a vehicle that operates in an automated mode. As used herein, “automated mode” can refer to navigating and/or maneuvering the vehicle 1200 along a travel route using one or more computing systems to control the vehicle 1200 with minimal or no input from a human driver. In one or more embodiments, the vehicle 1200 can be highly automated or completely automated. In one embodiment, the vehicle 1200 can be configured with one or more semi-automated operational modes in which one or more computing systems perform a portion of the navigation and/or maneuvering of the vehicle along a travel route, and a vehicle operator (i.e., driver) provides inputs to the vehicle 1200 to perform a portion of the navigation and/or maneuvering of the vehicle 1200 along a travel route.

For example, Standard J3016 202104, Taxonomy and Definitions for Terms Related to Driving Automation Systems for On-Road Motor Vehicles, issued by the Society of Automotive Engineers (SAE) International on Jan. 16, 2014, and most recently revised on Apr. 30, 2021, defines six levels of driving automation. These six levels include: (1) level 0, no automation, in which all aspects of dynamic driving tasks are performed by a human driver; (2) level 1, driver assistance, in which a driver assistance system, if selected, can execute, using information about the driving environment, either steering or acceleration/deceleration tasks, but all remaining driving dynamic tasks are performed by a human driver; (3) level 2, partial automation, in which one or more driver assistance systems, if selected, can execute, using information about the driving environment, both steering and acceleration/deceleration tasks, but all remaining driving dynamic tasks are performed by a human driver; (4) level 3, conditional automation, in which an automated driving system, if selected, can execute all aspects of dynamic driving tasks with an expectation that a human driver will respond appropriately to a request to intervene; (5) level 4, high automation, in which an automated driving system, if selected, can execute all aspects of dynamic driving tasks even if a human driver does not respond appropriately to a request to intervene; and (6) level 5, full automation, in which an automated driving system can execute all aspects of dynamic driving tasks under all roadway and environmental conditions that can be managed by a human driver.

The vehicle 1200 can include various elements. The vehicle 1200 can have any combination of the various elements illustrated in FIG. 12. In various embodiments, it may not be necessary for the vehicle 1200 to include all of the elements illustrated in FIG. 12. Furthermore, the vehicle 1200 can have elements in addition to those illustrated in FIG. 12. While the various elements are illustrated in FIG. 12 as being located within the vehicle 1200, one or more of these elements can be located external to the vehicle 1200. Furthermore, the elements illustrated may be physically separated by large distances. For example, as described, one or more components of the disclosed system can be implemented within the vehicle 1200 while other components of the system can be implemented within a cloud-computing environment, as described below. For example, the elements can include one or more processors 1210, one or more data stores 1215, a sensor system 1220, an input system 1230, an output system 1235, vehicle systems 1240, one or more actuators 1250, one or more automated driving modules 1260, a communications system 1270, and the system 200 for producing a map of a parking facility.

In one or more arrangements, the one or more processors 1210 can be a main processor of the vehicle 1200. For example, the one or more processors 1210 can be an electronic control unit (ECU). For example, functions and/or operations of one or more of the processor 162 (illustrated in FIG. 1) or the processor 202 (illustrated in FIG. 2) can be realized by the one or more processors 1210.

The one or more data stores 1215 can store, for example, one or more types of data. The one or more data stores 1215 can include volatile memory and/or non-volatile memory. Examples of suitable memory for the one or more data stores 1215 can include Random-Access Memory (RAM), flash memory, Read-Only Memory (ROM), Programmable Read-Only Memory (PROM), Erasable Programmable Read-Only Memory (EPROM), Electrically Erasable Programmable Read-Only Memory (EEPROM), registers, magnetic disks, optical disks, hard drives, any other suitable storage medium, or any combination thereof. The one or more data stores 1215 can be a component of the one or more processors 1210. Additionally or alternatively, the one or more data stores 1215 can be operatively connected to the one or more processors 1210 for use thereby. As used herein, “operatively connected” can include direct or indirect connections, including connections without direct physical contact. As used herein, a statement that a component can be “configured to” perform an operation can be understood to mean that the component requires no structural alterations, but merely needs to be placed into an operational state (e.g., be provided with electrical power, have an underlying operating system running, etc.) in order to perform the operation. For example, functions and/or operations of one or more of the memory 164 (illustrated in FIG. 1) or the memory 204 (illustrated in FIG. 2) can be realized by the one or more data stores 1215.

In one or more arrangements, the one or more data stores 1215 can store map data 1216. The map data 1216 can include maps of one or more geographic areas. In some instances, the map data 1216 can include information or data on roads, traffic control devices, road markings, structures, features, and/or landmarks in the one or more geographic areas. The map data 1216 can be in any suitable form. In some instances, the map data 1216 can include aerial views of an area. In some instances, the map data 1216 can include ground views of an area, including 360-degree ground views. The map data 1216 can include measurements, dimensions, distances, and/or information for one or more items included in the map data 1216 and/or relative to other items included in the map data 1216. The map data 1216 can include a digital map with information about road geometry. The map data 1216 can be high quality and/or highly detailed.

In one or more arrangements, the map data 1216 can include one or more terrain maps 1217. The one or more terrain maps 1217 can include information about the ground, terrain, roads, surfaces, and/or other features of one or more geographic areas. The one or more terrain maps 1217 can include elevation data of the one or more geographic areas. The map data 1216 can be high quality and/or highly detailed. The one or more terrain maps 1217 can define one or more ground surfaces, which can include paved roads, unpaved roads, land, and other things that define a ground surface.

In one or more arrangements, the map data 1216 can include one or more static obstacle maps 1218. The one or more static obstacle maps 1218 can include information about one or more static obstacles located within one or more geographic areas. A “static obstacle” can be a physical object whose position does not change (or does not substantially change) over a period of time and/or whose size does not change (or does not substantially change) over a period of time. Examples of static obstacles can include trees, buildings, curbs, fences, railings, medians, utility poles, statues, monuments, signs, benches, furniture, mailboxes, large rocks, and hills. The static obstacles can be objects that extend above ground level. The one or more static obstacles included in the one or more static obstacle maps 1218 can have location data, size data, dimension data, material data, and/or other data associated with them. The one or more static obstacle maps 1218 can include measurements, dimensions, distances, and/or information for one or more static obstacles. The one or more static obstacle maps 1218 can be high quality and/or highly detailed. The one or more static obstacle maps 1218 can be updated to reflect changes within a mapped area.

In one or more arrangements, the one or more data stores 1215 can store sensor data 1219. As used herein, “sensor data” can refer to any information about the sensors with which the vehicle 1200 can be equipped including the capabilities of and other information about such sensors. The sensor data 1219 can relate to one or more sensors of the sensor system 1220. For example, in one or more arrangements, the sensor data 1219 can include information about one or more lidar sensors 1224 of the sensor system 1220.

In some arrangements, at least a portion of the map data 1216 and/or the sensor data 1219 can be located in the one or more data stores 1215 that are located onboard the vehicle 1200. Additionally or alternatively, at least a portion of the map data 1216 and/or the sensor data 1219 can be located in the one or more data stores 1215 that are located remotely from the vehicle 1200.

The sensor system 1220 can include one or more sensors. As used herein, a “sensor” can refer to any device, component, and/or system that can detect and/or sense something. The one or more sensors can be configured to detect and/or sense in real-time. As used herein, the term “real-time” can refer to a level of processing responsiveness that is perceived by a user or system to be sufficiently immediate for a particular process or determination to be made, or that enables the processor to keep pace with some external process.

In arrangements in which the sensor system 1220 includes a plurality of sensors, the sensors can work independently from each other. Alternatively, two or more of the sensors can work in combination with each other. In such a case, the two or more sensors can form a sensor network. The sensor system 1220 and/or the one or more sensors can be operatively connected to the one or more processors 1210, the one or more data stores 1215, and/or another element of the vehicle 1200 (including any of the elements illustrated in FIG. 12). The sensor system 1220 can acquire data of at least a portion of the external environment of the vehicle 1200 (e.g., nearby vehicles). The sensor system 1220 can include any suitable type of sensor. Various examples of different types of sensors are described herein. However, one of skill in the art understands that the embodiments are not limited to the particular sensors described herein.

The sensor system 1220 can include one or more vehicle sensors 1221. The one or more vehicle sensors 1221 can detect, determine, and/or sense information about the vehicle 1200 itself. In one or more arrangements, the one or more vehicle sensors 1221 can be configured to detect and/or sense position and orientation changes of the vehicle 1200 such as, for example, based on inertial acceleration. In one or more arrangements, the one or more vehicle sensors 1221 can include one or more accelerometers, one or more gyroscopes, an inertial measurement unit (IMU), a dead-reckoning system, a global navigation satellite system (GNSS), a global positioning system (GPS), a navigation system 1247, and/or other suitable sensors. The one or more vehicle sensors 1221 can be configured to detect and/or sense one or more characteristics of the vehicle 1200. In one or more arrangements, the one or more vehicle sensors 1221 can include a speedometer to determine a current speed of the vehicle 1200.

Additionally or alternatively, the sensor system 1220 can include one or more environment sensors 1222 configured to acquire and/or sense driving environment data. As used herein, “driving environment data” can include data or information about the external environment in which a vehicle is located or one or more portions thereof. For example, the one or more environment sensors 1222 can be configured to detect, quantify, and/or sense obstacles in at least a portion of the external environment of the vehicle 1200 and/or information/data about such obstacles. Such obstacles may be stationary objects and/or dynamic objects. The one or more environment sensors 1222 can be configured to detect, measure, quantify, and/or sense other things in the external environment of the vehicle 1200 such as, for example, lane markers, signs, traffic lights, traffic signs, lane lines, crosswalks, curbs proximate the vehicle 1200, off-road objects, etc.

Various examples of sensors of the sensor system 1220 are described herein. The example sensors may be part of the one or more vehicle sensors 1221 and/or the one or more environment sensors 1222. However, one of skill in the art understands that the embodiments are not limited to the particular sensors described.

In one or more arrangements, the one or more environment sensors 1222 can include one or more radar sensors 1223, one or more lidar sensors 1224, one or more sonar sensors 1225, and/or one or more cameras 1226. In one or more arrangements, the one or more cameras 1226 can be one or more high dynamic range (HDR) cameras or one or more infrared (IR) cameras. For example, the one or more cameras 1226 can be used to record a reality of a state of an item of information that can appear in the digital map.

The input system 1230 can include any device, component, system, element, arrangement, or groups thereof that enable information/data to be entered into a machine. The input system 1230 can receive an input from a vehicle passenger (e.g., a driver or a passenger). The output system 1235 can include any device, component, system, element, arrangement, or groups thereof that enable information/data to be presented to a vehicle passenger (e.g., a driver or a passenger).

Various examples of the vehicle systems 1240 are illustrated in FIG. 12. However, one of skill in the art understands that the vehicle 1200 can include more, fewer, or different vehicle systems. Although particular vehicle systems can be separately defined, each or any of the systems or portions thereof may be otherwise combined or segregated via hardware and/or software within the vehicle 1200. For example, the vehicle systems 1240 can include a propulsion system 1241, a braking system 1242, a steering system 1243, a throttle system 1244, a transmission system 1245, a signaling system 1246, and/or the navigation system 1247. Each of these systems can include one or more devices, components, and/or a combination thereof, now known or later developed.

The navigation system 1247 can include one or more devices, applications, and/or combinations thereof, now known or later developed, configured to determine the geographic location of the vehicle 1200 and/or to determine a travel route for the vehicle 1200. The navigation system 1247 can include one or more mapping applications to determine a travel route for the vehicle 1200. The navigation system 1247 can include a global positioning system, a local positioning system, a geolocation system, and/or a combination thereof.

The one or more actuators 1250 can be any element or combination of elements operable to modify, adjust, and/or alter the vehicle systems 1240 or components thereof responsive to receiving signals or other inputs from the one or more processors 1210 and/or the one or more automated driving modules 1260. Any suitable actuator can be used. For example, the one or more actuators 1250 can include motors, pneumatic actuators, hydraulic pistons, relays, solenoids, and/or piezoelectric actuators.

The one or more processors 1210 and/or the one or more automated driving modules 1260 can be operatively connected to communicate with the vehicle systems 1240 and/or individual components thereof. For example, the one or more processors 1210 and/or the one or more automated driving modules 1260 can be in communication to send and/or receive information from the vehicle systems 1240 to control the movement, speed, maneuvering, heading, direction, etc. of the vehicle 1200. The one or more processors 1210 and/or the one or more automated driving modules 1260 may control some or all of the vehicle systems 1240 and, thus, may be partially or fully automated.

The one or more processors 1210 and/or the one or more automated driving modules 1260 may be operable to control the navigation and/or maneuvering of the vehicle 1200 by controlling one or more of the vehicle systems 1240 and/or components thereof. For example, when operating in an automated mode, the one or more processors 1210 and/or the one or more automated driving modules 1260 can control the direction and/or speed of the vehicle 1200. The one or more processors 1210 and/or the one or more automated driving modules 1260 can cause the vehicle 1200 to accelerate (e.g., by increasing the supply of fuel provided to the engine), decelerate (e.g., by decreasing the supply of fuel to the engine and/or by applying brakes) and/or change direction (e.g., by turning the front two wheels). As used herein, “cause” or “causing” can mean to make, force, compel, direct, command, instruct, and/or enable an event or action to occur or at least be in a state where such event or action may occur, either in a direct or indirect manner.

The communications system 1270 can include one or more receivers 1271 and/or one or more transmitters 1272. The communications system 1270 can receive and transmit one or more messages through one or more wireless communications channels. For example, the one or more wireless communications channels can be in accordance with the Institute of Electrical and Electronics Engineers (IEEE) 802.11p standard to add wireless access in vehicular environments (WAVE) (the basis for Dedicated Short-Range Communications (DSRC)), the 3rd Generation Partnership Project (3GPP) Long-Term Evolution (LTE) Vehicle-to-Everything (V2X) (LTE-V2X) standard (including the LTE Uu interface between a mobile communication device and an Evolved Node B of the Universal Mobile Telecommunications System), the 3GPP fifth generation (5G) New Radio (NR) Vehicle-to-Everything (V2X) standard (including the 5G NR Uu interface), or the like. For example, the communications system 1270 can include “connected vehicle” technology. “Connected vehicle” technology can include, for example, devices to exchange communications between a vehicle and other devices in a packet-switched network. Such other devices can include, for example, another vehicle (e.g., “Vehicle to Vehicle” (V2V) technology), roadside infrastructure (e.g., “Vehicle to Infrastructure” (V2I) technology), a cloud platform (e.g., “Vehicle to Cloud” (V2C) technology), a pedestrian (e.g., “Vehicle to Pedestrian” (V2P) technology), or a network (e.g., “Vehicle to Network” (V2N) technology. “Vehicle to Everything” (V2X) technology can integrate aspects of these individual communications technologies. For example, functions and/or operations of the communications device 166 (illustrated in FIG. 1) can be realized by the communications system 1270.

Moreover, the one or more processors 1210, the one or more data stores 1215, and the communications system 1270 can be configured to one or more of form a micro cloud, participate as a member of a micro cloud, or perform a function of a leader of a micro cloud. A micro cloud can be characterized by a distribution, among members of the micro cloud, of one or more of one or more computing resources or one or more data storage resources in order to collaborate on executing operations. The members can include at least connected vehicles.

The vehicle 1200 can include one or more modules, at least some of which are described herein. The modules can be implemented as computer-readable program code that, when executed by the one or more processors 1210, implement one or more of the various processes described herein. One or more of the modules can be a component of the one or more processors 1210. Additionally or alternatively, one or more of the modules can be executed on and/or distributed among other processing systems to which the one or more processors 1210 can be operatively connected. The modules can include instructions (e.g., program logic) executable by the one or more processors 1210. Additionally or alternatively, the one or more data stores 1215 may contain such instructions.

In one or more arrangements, one or more of the modules described herein can include artificial or computational intelligence elements, e.g., neural network, fuzzy logic, or other machine learning algorithms. Further, in one or more arrangements, one or more of the modules can be distributed among a plurality of the modules described herein. In one or more arrangements, two or more of the modules described herein can be combined into a single module.

The vehicle 1200 can include one or more automated driving modules 1260. The one or more automated driving modules 1260 can be configured to receive data from the sensor system 1220 and/or any other type of system capable of capturing information relating to the vehicle 1200 and/or the external environment of the vehicle 1200. In one or more arrangements, the one or more automated driving modules 1260 can use such data to generate one or more driving scene models. The one or more automated driving modules 1260 can determine position and velocity of the vehicle 1200. The one or more automated driving modules 1260 can determine the location of obstacles, obstacles, or other environmental features including traffic signs, trees, shrubs, neighboring vehicles, pedestrians, etc.

The one or more automated driving modules 1260 can be configured to receive and/or determine location information for obstacles within the external environment of the vehicle 1200 for use by the one or more processors 1210 and/or one or more of the modules described herein to estimate position and orientation of the vehicle 1200, vehicle position in global coordinates based on signals from a plurality of satellites, or any other data and/or signals that could be used to determine the current state of the vehicle 1200 or determine the position of the vehicle 1200 with respect to its environment for use in either creating a map or determining the position of the vehicle 1200 in respect to map data.

The one or more automated driving modules 1260 can be configured to determine one or more travel paths, current automated driving maneuvers for the vehicle 1200, future automated driving maneuvers and/or modifications to current automated driving maneuvers based on data acquired by the sensor system 1220, driving scene models, and/or data from any other suitable source such as determinations from the sensor data 1219. As used herein, “driving maneuver” can refer to one or more actions that effect the movement of a vehicle. Examples of driving maneuvers include: accelerating, decelerating, braking, turning, moving in a lateral direction of the vehicle 1200, changing travel lanes, merging into a travel lane, and/or reversing, just to name a few possibilities. The one or more automated driving modules 1260 can be configured to implement determined driving maneuvers. The one or more automated driving modules 1260 can cause, directly or indirectly, such automated driving maneuvers to be implemented. As used herein, “cause” or “causing” means to make, command, instruct, and/or enable an event or action to occur or at least be in a state where such event or action may occur, either in a direct or indirect manner. The one or more automated driving modules 1260 can be configured to execute various vehicle functions and/or to transmit data to, receive data from, interact with, and/or control the vehicle 1200 or one or more systems thereof (e.g., one or more of vehicle systems 1240). For example, functions and/or operations of an automotive navigation system can be realized by the one or more automated driving modules 1260.

Detailed embodiments are disclosed herein. However, one of skill in the art understands, in light of the description herein, that the disclosed embodiments are intended only as examples. Therefore, specific structural and functional details disclosed herein are not to be interpreted as limiting, but merely as a basis for the claims and as a representative basis for teaching one of skill in the art to variously employ the aspects herein in virtually any appropriately detailed structure. Furthermore, the terms and phrases used herein are not intended to be limiting but rather to provide an understandable description of possible implementations. Various embodiments are illustrated in FIGS. 1-12, but the embodiments are not limited to the illustrated structure or application.

The flowchart and block diagrams in the figures illustrate the architecture, functionality, and operation of possible implementations of systems, methods, and computer program products according to various embodiments. In this regard, each block in flowcharts or block diagrams may represent a module, segment, or portion of code, which comprises one or more executable instructions for implementing the specified logical function(s). One of skill in the art understands, in light of the description herein, that, in some alternative implementations, the functions described in a block may occur out of the order depicted by the figures. For example, two blocks depicted in succession may, in fact, be executed substantially concurrently, or the blocks may be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suitable. A typical combination of hardware and software can be a processing system with computer-readable program code that, when loaded and executed, controls the processing system such that it carries out the methods described herein. The systems, components, and/or processes also can be embedded in a computer-readable storage, such as a computer program product or other data programs storage device, readable by a machine, tangibly embodying a program of instructions executable by the machine to perform methods and processes described herein. These elements also can be embedded in an application product that comprises all the features enabling the implementation of the methods described herein and that, when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. As used herein, the phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples of the computer-readable storage medium would include, in a non-exhaustive list, the following: a portable computer diskette, a hard disk drive (HDD), a solid-state drive (SSD), a read-only memory (ROM), an erasable programmable read-only memory (EPROM or flash memory), a portable compact disc read-only memory (CD-ROM), a digital versatile disc (DVD), an optical storage device, a magnetic storage device, or any suitable combination of the foregoing. As used herein, a computer-readable storage medium may be any tangible medium that can contain or store a program for use by or in connection with an instruction execution system, apparatus, or device.

Generally, modules, as used herein, include routines, programs, objects, components, data structures, and so on that perform particular tasks or implement particular data types. In further aspects, a memory generally stores such modules. The memory associated with a module may be a buffer or may be cache embedded within a processor, a random-access memory (RAM), a ROM, a flash memory, or another suitable electronic storage medium. In still further aspects, a module as used herein, may be implemented as an application-specific integrated circuit (ASIC), a hardware component of a system on a chip (SoC), a programmable logic array (PLA), or another suitable hardware component (e.g., a central processing unit (CPU), a graphics processing unit (GPU), a field-programmable gate array (FPGA), or the like) that is embedded with a defined configuration set (e.g., instructions) for performing the disclosed functions.

Program code embodied on a computer-readable medium may be transmitted using any appropriate medium, including but not limited to wireless, wireline, optical fiber, cable, radio frequency (RF), etc., or any suitable combination of the foregoing. Computer program code for carrying out operations for aspects of the disclosed technologies may be written in any combination of one or more programming languages, including an object-oriented programming language such as Java™, Smalltalk, C++, or the like, and conventional procedural programming languages such as the “C” programming language or similar programming languages. The program code may execute entirely on a user's computer, partly on a user's computer, as a stand-alone software package, partly on a user's computer and partly on a remote computer, or entirely on a remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . or . . . ” as used herein refers to and encompasses any and all possible combinations of one or more of the associated listed items. For example, the phrase “at least one of A, B, or C” includes A only, B only, C only, or any combination thereof (e.g., AB, AC, BC, or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A system, comprising:
a processor; and
a memory storing:
an ensemble of experts module including instructions that cause the processor to:
segment, operating at least one first neural network-based model, a remote sensing image of a parking facility to produce bounding boxes of parking blocks;
segment, operating at least one second neural network-based model, an object, in the remote sensing image, associated with obscuring the bounding boxes; and
modify, to produce a map of the parking facility, the bounding boxes to account for an effect of the object; and
a communications module including instructions that cause the processor to communicate the map to a device associated with a vehicle to control an operation of the device.

2. The system of claim 1, wherein:
the at least one first neural network-based model comprises a first first neural network-based model and second first neural network-based model,
the first first neural network-based model is a parking facility segmentation expert model configured to segment an overall layout of the parking facility to produce at least one parking facility mask,
the second first neural network-based model is a parking block segmentation expert model configured to segment individual parking blocks to produce at least one parking block mask, a parking block being a row of parking spots in which all of the parking spots are oriented in a same direction, and
the instructions to segment the remote sensing image to produce the bounding boxes of the parking blocks include:
instructions to merge the at least one parking facility mask and the at least one parking block mask to produce a merged parking block mask, and
instructions to extract at least one bounding box to define at least one parking block.

3. The system of claim 2, wherein the instructions to merge the at least one parking facility mask and the at least one parking block mask include instructions to perform a pixel-wise AND combination of the at least one parking facility mask and the at least one parking block mask.

4. The system of claim 2, wherein the instructions to merge the at least one parking facility mask and the at least one parking block mask include instructions to remove at least one false positive indication, associated with a parking block, in the at least one parking block mask.

5. The system of claim 2, wherein:
the at least one second neural network-based model comprises a first second neural network-based model,
the first second neural network-based model is a tree segmentation expert model configured to:
identify the object as a tree, and
segment the object, and
the instructions to modify the bounding boxes to account for the effect of the object include:
instructions to identify, among the at least one bounding box, two bounding boxes that overlap a segmentation of the object,
instructions to connect the two bounding boxes to produce at least one refined bounding box to define a single parking block, and
instructions to extract parking spot lines within at least one of the at least one bounding box or the at least one refined bounding box.

6. The system of claim 5, wherein:
the object comprises a first object and a second object,
the first object is the tree,
the at least one second neural network-based model further comprises a second second neural network-based model, and
the second second neural network-based model is a parked vehicle detection expert model configured to:
identify the second object as a vehicle,
segment the second object, and
extract an object bounding box for the second object.

7. The system of claim 6, wherein:
the effect of the object comprises an effect of the second object, and
the effect of the second object comprises at least one of:
a location of the second object obscures a parking spot line, or
a shadow of the second object obscures the parking spot line.

8. The system of claim 6, wherein the ensemble of experts module is configured to perform:
the instructions to segment the remote sensing image of the parking facility to produce the bounding boxes of the parking blocks,
the instructions to segment the object associated with obscuring the bounding boxes;
the instructions to identify the two bounding boxes that overlap the segmentation of the object,
the instructions to connect the two bounding boxes to produce the at least one refined bounding box to define the single parking block, and
the instructions to extract the parking spot lines within the at least one of the at least one bounding box or the at least one refined bounding box.

9. The system of claim 6, wherein the memory further stores a map production module including instructions that cause the processor to:
cluster the parking spot lines and the object bounding box to produce refined parking spot lines, and
add, to produce the map of the parking facility, possible missing parking spot lines by at least one of:
interpolating with respect to the at least one of the at least one bounding box or the at least one refined bounding box, or
extending a partial parking spot line.

10. The system of claim 9, wherein the instructions to cluster the parking spot lines and the object bounding box include a hierarchical technique that:
identifies angle clusters,
identifies distance clusters within the angle clusters, and
merges lines within each distance cluster, within the distance clusters, into a single representation.

11. The system of claim 9, wherein the instructions to add the possible missing parking spot lines include instructions to verify a preliminary determination of a size of a parking spot with respect to a standard size of the parking spot.

12. The system of claim 9, wherein the map production module is configured to perform:
the instructions to cluster the parking spot lines and the object bounding box, and
the instructions to add the possible missing parking spot lines.

13. The system of claim 1, wherein:
the processor is disposed on a cloud computing platform, and
the instructions to communicate the map to the device associated with the vehicle include instructions to communicate the map to the vehicle.

14. The system of claim 1, wherein the processor is disposed on the vehicle.

15. The system of claim 1, wherein:
the object comprises a first object and a second object, and
the at least one second neural network-based model comprises a shadow removal expert model configured to:
identify the second object as a shadow of the first object, and
segment the second object.

16. The system of claim 1, wherein the at least one second neural network-based model comprises a tree segmentation expert model configured to:
identify the object as a tree, and
segment the object.

17. The system of claim 1, wherein the at least one second neural network-based model comprises a parked vehicle detection expert model configured to:
identify the object as a vehicle,
segment the object, and
extract an object bounding box for the object.

18. A method, comprising:
segmenting, by a processor operating at least one first neural network-based model, a remote sensing image of a parking facility to produce bounding boxes of parking blocks;
segmenting, by the processor operating at least one second neural network-based model, an object, in the remote sensing image, associated with obscuring the bounding boxes;
modifying, by the processor to produce a map of the parking facility, the bounding boxes to account for an effect of the object; and
communicating, by the processor, the map to a device associated with a vehicle to control an operation of the device.

19. The method of claim 18, wherein the device associated with the vehicle comprises at least one of:
a device associated with an automated valet parking system,
a device associated with a smart parking system,
a device associated with a system configured to produce a parking spot recommendation, or
a device associated with a system configured to determine an optimal route to a parking spot.

20. A non-transitory computer-readable medium for producing a map of a parking facility, the non-transitory computer-readable medium including instructions that, when executed by one or more processors, cause the one or more processors to:
segment, operating at least one first neural network-based model, a remote sensing image of the parking facility to produce bounding boxes of parking blocks;
segment, operating at least one second neural network-based model, an object, in the remote sensing image, associated with obscuring the bounding boxes;
modify, to produce the map of the parking facility, the bounding boxes to account for an effect of the object; and
communicate the map to a device associated with a vehicle to control an operation of the device.
